(19) United States
(12) Patent Application Publication
(10) Pub. No.: US 2004/0092033 A1
(43) Pub. Date: May 13, 2004

(54) Systems and methods for preparing microfluidic devices for operation

(75) Inventors: Vincent K. Gustafson, Pasadena, CA (US); Steven E. Hobbs, West Hills, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/686,347

(22) Filed: Oct. 14, 2003

Related U.S. Application Data
(60) Provisional application No. 60/419,782, filed on Oct. 18, 2002.

(51) Int. Cl. G01N 1/10

(52) U.S. Cl. 436/180; 422/100

(57) ABSTRACT

Systems and method for removing undesirable gas from microfluidic separation devices to prepare them for operation are provided. The microfluidic devices contain separation media that provides a significant fluidic impedance. A vacuum source is used to evacuate gas from, and a positive pressure source is used to introduce liquid into, the microfluidic device to minimize the presence of undesirable bubbles. Where hydrophobic materials are present within the microfluidic device, the liquid may be an organic solvent. Positive pressures of at least about 100 psi are preferably employed. A microfluidic separation device may include multiple separation columns and a distribution network in fluid communication with the columns.

### FIELD OF THE INVENTION

The present invention relates to the operation of microfluidic devices, and more particularly to systems and methods for removing undesirable gas from microfluidic devices to prepare them for operation.

### BACKGROUND OF THE INVENTION

Optical detectors are used frequently in analytical fluid systems. It is generally desirable to avoid the presence of bubbles in systems directed to optical detection of liquid or solute properties since bubbles can significantly interfere with optical measurements. Examples of common optical detection technologies in use today include refractive index, UV/Vis (including fixed wavelength, variable wavelength, and diode array), and fluorescence.

Various techniques for performing chemical and biological separations are used in conjunction with optical detectors to determine the presence and/or quantity of individual species in complex mixtures. One separation technique, liquid chromatography (“LC”), includes methods used for separating closely related components of mixtures. Pressure-driven systems are common. In high pressure liquid chromatography (“HPLC”) systems, high pressure mobile phase (typically a solvent or solvent mixture pressurized with a pump) is supplied to a separation column containing a stationary phase material. Pressures of up to several thousand pounds per square inch are commonly used. A sample is injected into the system and carried by the mobile phase through the column where it is separated into its various species. A typical HPLC column includes a stainless steel tube with a high precision internal bore, ferrules, threaded end fittings, frits, and packing material (typically densely packed small porous adsorbent particles, such as 5-10 micron size). Standard HPLC chromatography columns have dimensions of several (e.g., 10, 15, 25) centimeters in length and between 3-5 millimeters in diameter, although smaller capillary columns having internal diameters between 3-200 microns are also available.

A conventional HPLC system utilizing a column 10 is illustrated in FIG. 1. The system 30 includes a solvent reservoir 32, a solvent degasser 31, at least one high pressure pump 34, a pulse damper 36, a sample injection (loop) valve 38, a sample source 40, and, downstream of the column 10, a detector 42 (typically an optical detector for detecting the separated species) and a waste reservoir 44 or other collection means. The high pressure pump 34 pumps mobile phase solvent from the reservoir 32. The solvent degasser 31 helps reduce the presence of gas in the solvent that could lead bubbles to be carried downstream in the system 30. A pulse damper 36 serves to reduce pressure pulses caused by the pump 34. The sample injection valve 38 is typically a rotary valve having an internal sample loop for injecting a predetermined volume of sample from the sample source 40 into the solvent stream. Downstream of the sample injection valve 38, the column 10 contains stationary phase material that aids in separating species of the sample.

Using conventional HPLC columns, separations are performed serially (i.e., one at a time). A new separation column connects to an associated HPLC system with high-pressure threaded fittings, and a column is readied for initial operation by pumping solvent through it until it is thoroughly wetted and all bubbles are removed from the system. When one separation is complete, a column may be flushed with solvent and re-used. Conventional HPLC columns are re-used many (often on the order of 100 or more) times before they become so contaminated that their effectiveness is diminished. One downside risk of column re-use, however, is the potential for detrimental sample carryover from one separation to the next. Ideally, a new column would be used for each separation, but this ideal would be impractical due to (1) the high cost of HPLC columns; and (2) the time required to both change HPLC columns (due to the threaded end fittings) and prepare them for initial use by purging air from the system. But since HPLC columns are in fact re-used many times, the time required to change columns and prepare them for initial use is “amortized” over a large number of uses, thus reducing the significance of the delay and associated system downtime to tolerable levels.

Recent advances in microfluidic technology have allowed fabrication of high-throughput microfluidic HPLC devices having multiple separation columns permitting simultaneous separation of multiple samples in parallel while using very small quantities of valuable samples and solvents. Examples of such devices are disclosed in U.S. Provisional Patent Application No. 60.357,683 (filed Feb. 13, 2002). These microfluidic devices require far fewer parts per column than conventional HPLC columns, and may be rapidly connected to an associated HPLC system without the use of threaded fittings, such as by using gaskets and compression means. Beyond the potential increase in throughput associated with parallel separation, a further benefit of multi-column microfluidic HPLC devices is that their relatively low cost and ease of connection permits them to be disposed of after a single or only a few uses, thus eliminating or dramatically reducing the potential for sample carryover from one separation to the next. Limitations exist, however, to using microfluidic HPLC devices. If optical detection is performed directly on a microfluidic device, the small sizes of the associated channels and optical detection windows tend to exacerbate bubble interference problems, and may make it more difficult to purge bubbles from such devices. Additionally, the disposable nature of these devices (i.e., their low number of re-use cycles) increases the frequency with which the user needs to change devices and ready them for initial use with solvent to purge air from the system. Thus, the problem of preparing a column for initial use takes on a special importance in the context of high throughput microfluidic HPLC devices to maximize their utility, since column preparation needs to be performed much more often than with conventional HPLC columns and this preparation time cannot be amortized over as many re-use cycles. Additionally, the presence of packed stationary material in such devices complicates the removal of bubbles.

The use of vacuum pumps and similar devices to direct the flow of liquids in microfluidic devices is well known. One benefit of using vacuum to induce flow in such systems is that it naturally evacuates any gases (e.g., air) disposed upstream of an advancing liquid front, thus minimizing the formation of bubbles. It is generally not feasible, however, to perform high performance liquid chromatography using vacuum-based liquid direction systems due to the impedance presented by stationary phase materials, which typically include packed particulate matter or microporous matrices to promote efficient separation. At desirable system flow rates, separation columns suitable for performing HPLC often present impedances of at least many tens, more often many hundreds, of pounds per square inch (psi). Since vacuum sources are limited to providing a pressure drop of only 14.7 psi (one atmosphere), these sources are generally incapable of generating a sufficient differential through separation columns to provide adequate separation efficiency.

In light of the foregoing, it would be desirable to reduce the time required to prepare a separation column for initial use. In particular, it would be desirable to purge air (or other gas) quickly from a separation column to minimize the presence of bubbles that may interfere with optical detection schemes and/or other processes. It would be further desirable to maintain high separation efficiency while minimizing bubble formation.

### BRIEF DESCRIPTION OF THE DRAWINGS

FIG. 1 is a schematic showing various components of a conventional high pressure liquid chromatography system employing a tubular packed HPLC column.

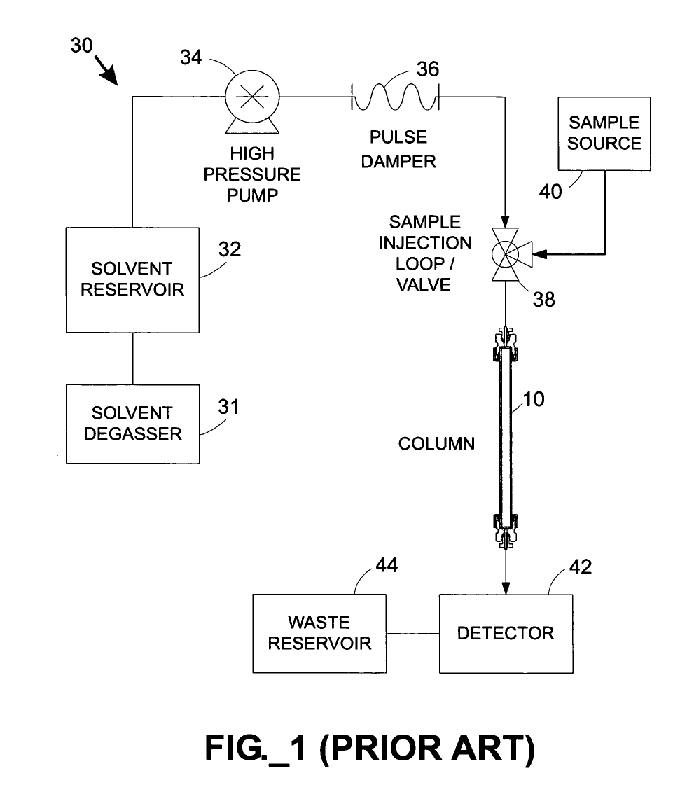

FIG. 2A is an exploded perspective view of a microfluidic device having eight separation columns suitable for performing pressure-driven liquid chromatography, the device having on-board detection capability.

FIG. 2B is a top view of the microfluidic device of FIG. 2A.

FIG. 3 is a top view of a multi-layer microfluidic device containing twenty-four separation columns suitable for performing pressure-driven liquid chromatography.

FIG. 4A is an exploded perspective view of a first portion, including the first through fourth layers, of the microfluidic device shown in FIG. 3.

FIG. 4B is an exploded perspective view of a second portion, including the fifth and sixth layers, of the microfluidic device shown in FIG. 3.

FIG. 4C is an exploded perspective view of a third portion, including the seventh and eighth layers, of the microfluidic device shown in FIG. 3.

FIG. 4D is an exploded perspective view of a fourth portion, including the ninth through twelfth layers, of the microfluidic device shown in FIG. 3.

FIG. 4E is a reduced size composite of FIGS. 4A-4D showing an exploded perspective view of the microfluidic device of FIG. 3.

FIG. 5 is a flow diagram showing the steps of a method for preparing a microfluidic device for operation.

FIG. 6 is a schematic showing various components of a first system adapted to quickly prepare a microfluidic separation device for operation, the system including a microfluidic separation device with on-board detection capability and a vacuum pump disposed downstream of the microfluidic device and detection regions.

FIG. 7 is a schematic showing various components of a second system adapted to quickly prepare a microfluidic separation device for operation, the system including a microfluidic separation device with on-board detection capability and a vacuum pump disposed upstream of the microfluidic device.

FIG. 8 is a schematic showing various components of a third system adapted to quickly prepare a microfluidic separation device for operation, the system including a microfluidic separation device with multiple outputs in fluid communication with off-board detection and including a vacuum interface disposed downstream of the detection component(s).

### DETAILED DESCRIPTION OF PREFERRED EMBODIMENTS OF THE INVENTION

### Definitions

The term “channel” as used herein is to be interpreted in a broad sense. Thus, it is not intended to be restricted to elongated configurations where the transverse or longitudinal dimension greatly exceeds the diameter or cross-sectional dimension. Rather, this term is meant to comprise cavities or tunnels of any desired shape or configuration through which liquids may be directed. A channel may be substantially filled or may contain internal structures comprising, for example, valves, filters, stationary phase media, and similar or equivalent components and materials.

The terms “column” and “separation column” as used herein are used interchangeably and refers to a region of a fluidic device that contains stationary phase material and is adapted to perform a separation process.

The term “fluidic distribution network” refers to an interconnected, branched group of channels and/or conduits adapted to divide a fluid 100

stream into multiple substreams.

The term “frit” as used herein refers to a liquid-permeable material adapted to retain stationary phase material within a separation column.

The term “microfluidic” as used herein refers to structures or devices through which one or more fluids are capable of being passed or directed and having at least one dimension less than about 500 microns.

The term “packed” as used herein refers to the state, of being substantially filled with a packing material (such as a particulate material).

The term “parallel” as used herein refers to the ability to concomitantly or substantially concurrently process two or more separate fluid volumes, and does not necessarily refer to a specific physical (e.g., channel) structure or layout.

The term “stencil” as used herein refers to a material layer or sheet that is preferably substantially planar through which one or more variously shaped and oriented portions have been cut or otherwise removed through the entire thickness of the layer, and that permits substantial fluid movement within the layer (e.g., in the form of channels or chambers, as opposed to simple through-holes for transmitting fluid through one layer to another layer). The outlines of the cut or otherwise removed portions form the lateral boundaries of microstructures that are formed when a stencil is sandwiched between other layers such as substrates or other stencils.

### Microfluidic Devices Generally

Devices used with methods according to the present invention are preferably microfluidic devices defining internal channels or other microstructures having at least one dimension smaller than about 500 microns. Preferably, these microfluidic devices are constructed using stencil layers or sheets to define channels and/or chambers. As noted previously, a stencil layer is preferably substantially planar and has a channel or chamber cut through the entire thickness of the layer to permit substantial fluid movement within the stencil layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely-dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permit robust devices to be fabricated quickly and inexpensively compared to other conventional microfluidic fabrication technologies, such as surface micromachining or material deposition techniques.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. In certain examples, particularly preferable materials include those that are substantially optically transmissive to permit viewing and/or electromagnetic analyses of fluid contents within a microfluidic device. Various examples may utilize porous materials, including filter materials, for device layers. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties.

Various means may be used to seal or bond layers of a device together, preferably to construct a substantially sealed structure. For example, adhesives may be used. In one example, one or more layers of a device may be fabricated from single- or double-sided adhesive tape, although other methods of adhering stencil layers may be used. A portion of the tape (of the desired shape and dimensions) can be cut and removed to form channels, chambers, and/or apertures. A tape stencil can then be placed on a supporting substrate with an appropriate cover layer, between layers of tape, or between layers of other materials. In one example, stencil layers can be stacked on each other. In this example, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an example. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thicknesses of these carrier materials and adhesives may be varied.

In another example, device layers may be directly bonded without using adhesives to provide high bond strength (which is especially desirable for high-pressure applications) and eliminate potential compatibility problems between such adhesives and solvents and/or samples. Specific examples of methods for directly bonding layers of unoriented polypropylene to form stencil-based microfluidic structures are disclosed in commonly assigned U.S. patent application Ser. No. 10/313,231 (filed Dec. 6, 2002), which is hereby incorporated by reference as if set forth fully herein. In one embodiment therein, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure fluidic processes.

Further examples of microfluidic devices may be fabricated from various materials using well-known techniques such as embossing, stamping, molding, and soft lithography.

Microfluidic channels can also be packed with stationary phase material to yield columns suitable for high pressure liquid chromatography. In preferred examples, multiple columns are integrated into a single microfluidic device to accomplish simultaneous separation of multiple samples in parallel. Representative devices and packing methods are disclosed in commonly assigned U.S. patent application Ser. No. 10/366,985 (filed Feb. 13, 2003), which is hereby incorporated by reference as if set forth fully herein.

### Multi-Column Microfluidic Separation Devices

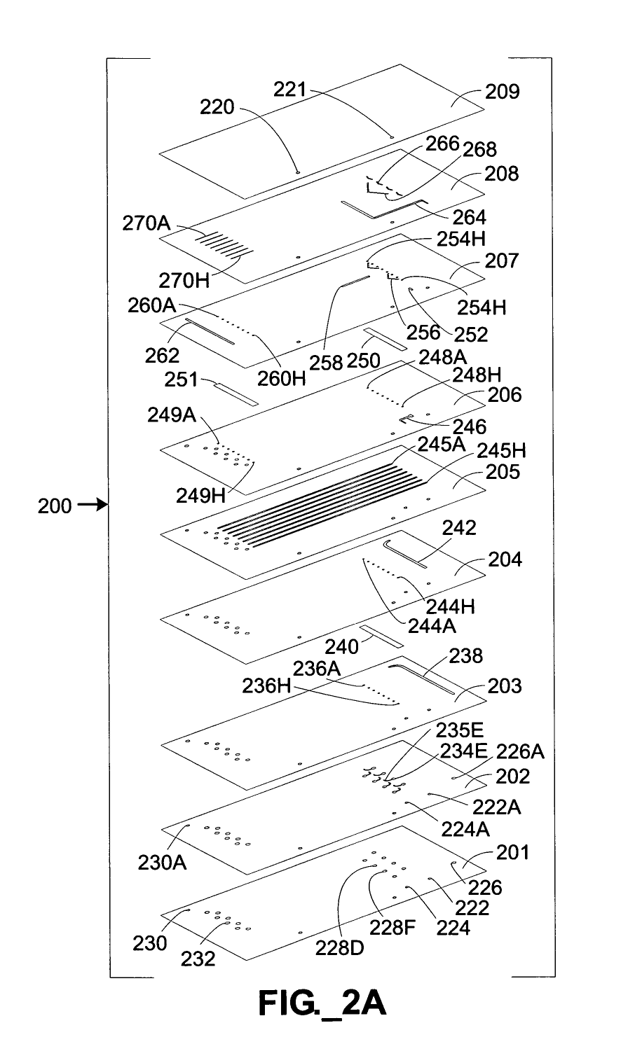

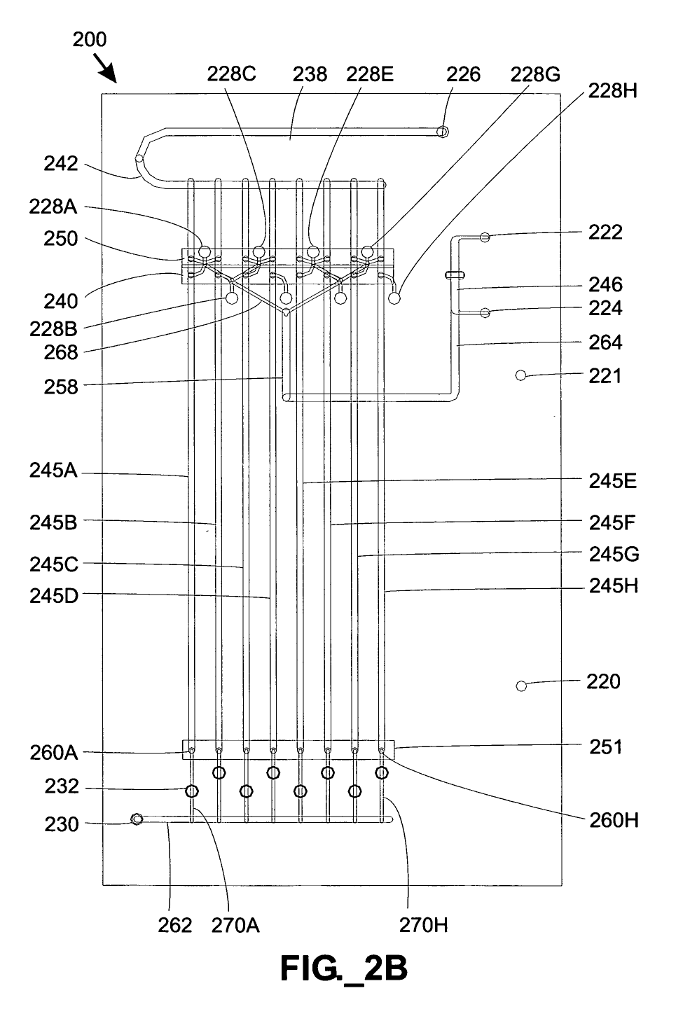

A preferred microfluidic separation device includes multiple separation channels and multiple discrete sample inputs to permit multiple different samples to be separated simultaneously. For example, FIGS. 2A-2B illustrate a microfluidic separation device 200 constructed with nine layers 201-209, including multiple stencil layers 202-208. Each of the nine layers 201-209 defines two alignment holes 220, 221, which are used in conjunction with external pins (not shown) to aid in aligning the layers 201-209 during construction, and/or to aid in aligning the device 200 with an external interface (not shown) during a slurry packing process. The first layer 201 defines several fluidic ports: two solvent inlet ports 222, 224 that are used to admit (mobile phase) solvent to the device 200; eight sample ports 228A-228G that permit sample to be introduced to eight separation channels 245A-245G columns (each containing stationary phase material); a slurry inlet port 226 that is used during a column packing procedure to admit slurry to the device 200; and a fluidic port 230 that is used [1] during the packing process to exhaust (slurry) solvent from the device 200; and [2] during operation of the separation device 200 to exit mobile phase solvent and sample from the device 200 following separation. The first through sixth layers 201-206 each define eight optical detection windows 232. Defining these windows 232 through the first six layers 201-206 16 facilitates optical detection since it reduces the amount of material between an optical detector (not shown) such as a conventional UV-Vis spectrometer/detector, and the samples contained in channel segments 270 downstream of the separation channels 245A-245H.

The second through seventh layers 202-207 each define solvent vias 222A to transport a first mobile phase solvent to a solvent channel 264 defined in the eighth layer 208, with further solvent vias 224A defined in the second through fifth layers 202-205 to transport a second mobile phase solvent to a second solvent channel 246 defined in the sixth layer 206. Further vias 230A are defined in the second through sixth layers 202-206 to provide a fluid path between the fluidic port 230 and the channel 262 defined in the seventh layer 207. A via 226 defined in the second layer 202 communicates slurry from the slurry inlet port 226 to an elongate channel 238 defined in the third layer 203 during the slurry packing process. Preferably, particulate material deposited by the slurry packing process fills a first common channel 242 and at least a portion of a further upstream channel 238. The second layer 202 further defines eight sample channels 235A-235H, each having an enlarged region 234A-234H, respectively. Each enlarged region 234A-234H is aligned with one of the eight corresponding sample inlet ports 228A-228H defined in the first layer 201.

The third layer 203 defines an elongate channel 238 along with eight sample vias 236A-236H, which are aligned with the small ends of the sample channels 235A-235H. The fourth layer 204 defines eight sample vias 244A-244H aligned with the vias 236A-236H in the third layer 203. A porous material or (sample) frit 240, which functions to retain stationary phase material in the separation channels 245A-245H but permits the passage of sample, is placed between the third and fourth layers 203, 204 and spans across the sample vias 244A-244H in the fourth layer 204. Although various frit materials may be used, the frit 240 (along with frits 250, 251 within the device 200) is preferably constructed from a permeable polypropylene membrane such as, for example, 1-mil (25 microns) thickness Celgard 2500 membrane (55% porosity, 0.209×0.054 micron pore size, Celgard Inc., Charlotte, N.C.)—particularly if the layers 201-209 of the device 200 are bonded together using an adhesiveless thermal bonding method. Applicants have obtained favorable results using this specific frit material, without noticeable wicking or lateral flow within the frit despite using a single strip of the frit membrane to serve multiple adjacent separation channels 245A-245H containing stationary phase material. This frit material is hydrophobic. As a less-preferred alternative to the single porous frit 240, multiple discrete frits (not shown) may be substituted, and various porous material types and thicknesses may be used depending on the stationary phase material to be retained. The fourth layer 204 further defines a manifold channel 242 that provides fluid communication with the separation channels 245A-245H defined in the fifth layer 205 and the elongate channel 238 defined in the third layer 203. The separation channels 245A-245H are preferably about 40 mils (1 mm) wide or smaller.

The sixth layer 206 defines a solvent channel 246 that receives a second mobile phase solvent and transports the same to the slit 252 (defined in the seventh layer 207), which facilitates mixing of the two solvents in the channel 264 downstream of the slit 252. Further defined in the sixth layer 206 are a first set of eight vias 248A-248H (for admitting mixed mobile phase solvents to the upstream end of the separation channels 245A-245H and the stationary phase material contained therein), and a second set of eight vias 249A-249H at the downstream end of the same channels 245A-245H for receiving mobile phase solvent and sample. Two frits 250, 251 are inserted between the sixth and the seventh layers 206, 207. The first (mobile phase solvent) frit 250 is placed immediately above the first set of eight vias 248A-248H, while the second (mobile phase+sample) frit 251 is placed immediately above the second set of eight vias 249A-249H and below a similar set of eight vias 260A-260H defined in the seventh layer 207. The seventh layer 207 defines a channel segment 258, two medium forked channel segments 268, and eight vias 254A-245H for communicating mobile phase solvent through the frit 250 and the vias 248A-248H to the separation channels 245A-245H defined in the fifth layer 205 and containing stationary phase material. The seventh layer 207 further defines a transverse manifold channel 262—that receives mobile phase solvent and sample following separation, and that receives (slurry) solvent during column packing—for routing fluids through vias 230A to the fluidic exit port 230. The eighth layer 208 defines a mixing channel 264, one large forked channel segment 268, and four small forked channel segments 266. The eighth layer 208 further defines eight parallel channel segments 270A-270H downstream of the frit 251 for receiving (mobile phase) solvent and sample (during separation) or (slurry) solvent (during slurry packing), and for transporting such fluid(s) to the manifold channel 262 defined in the seventh layer 207. The ninth layer 209 serves as a cover for the channel structures defined in the eighth layer 208.

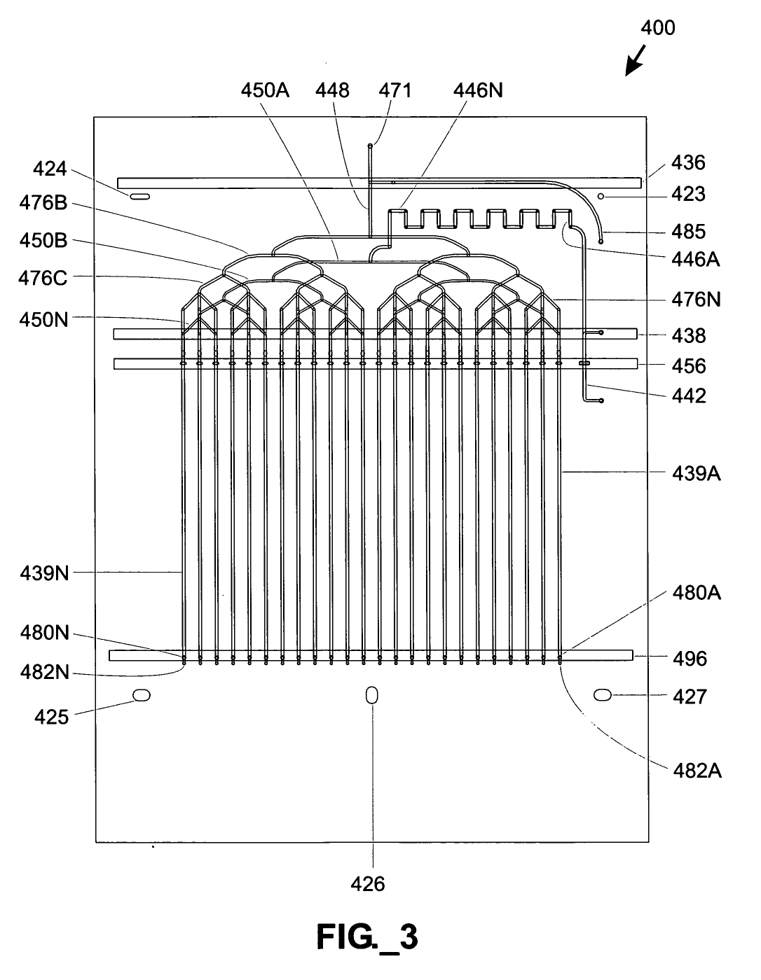

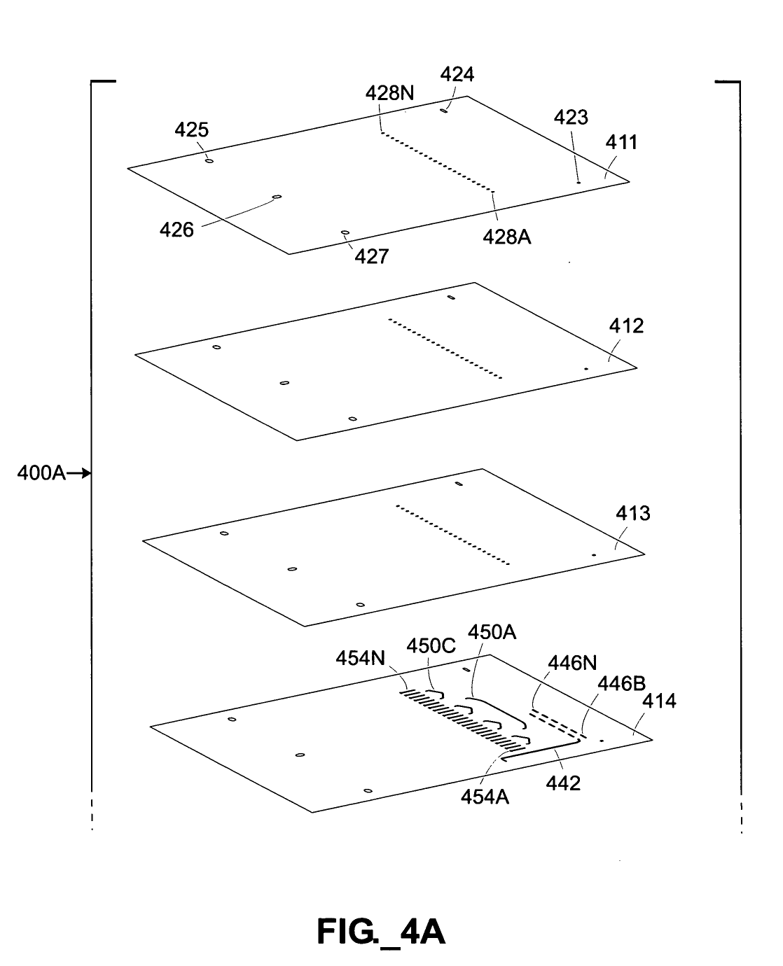

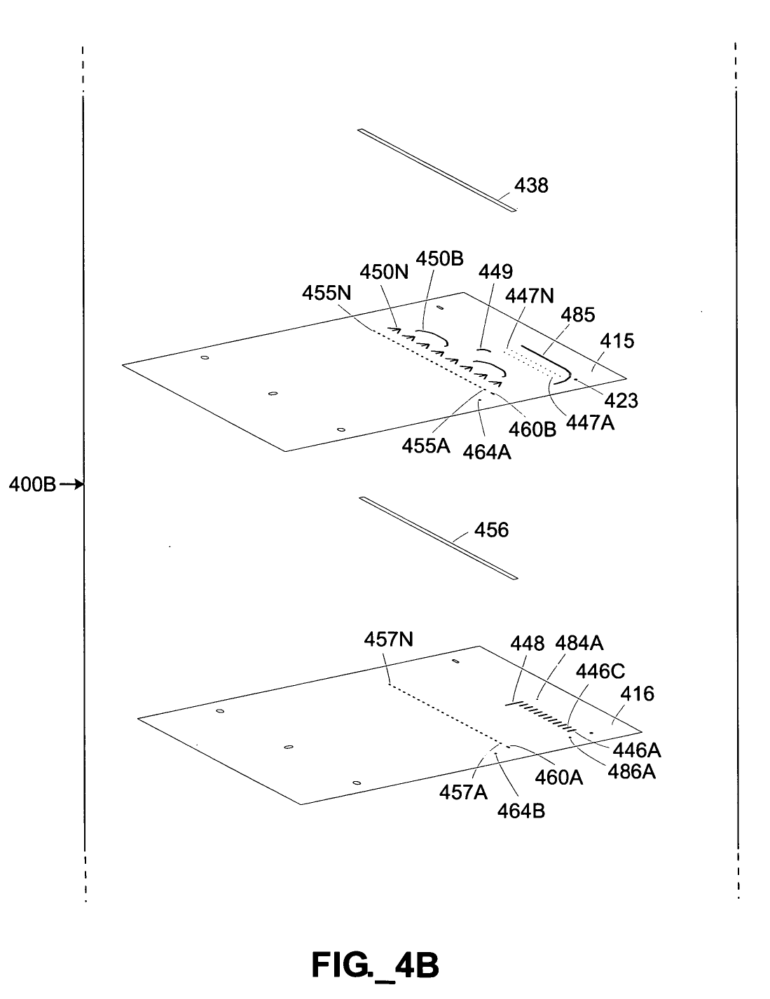

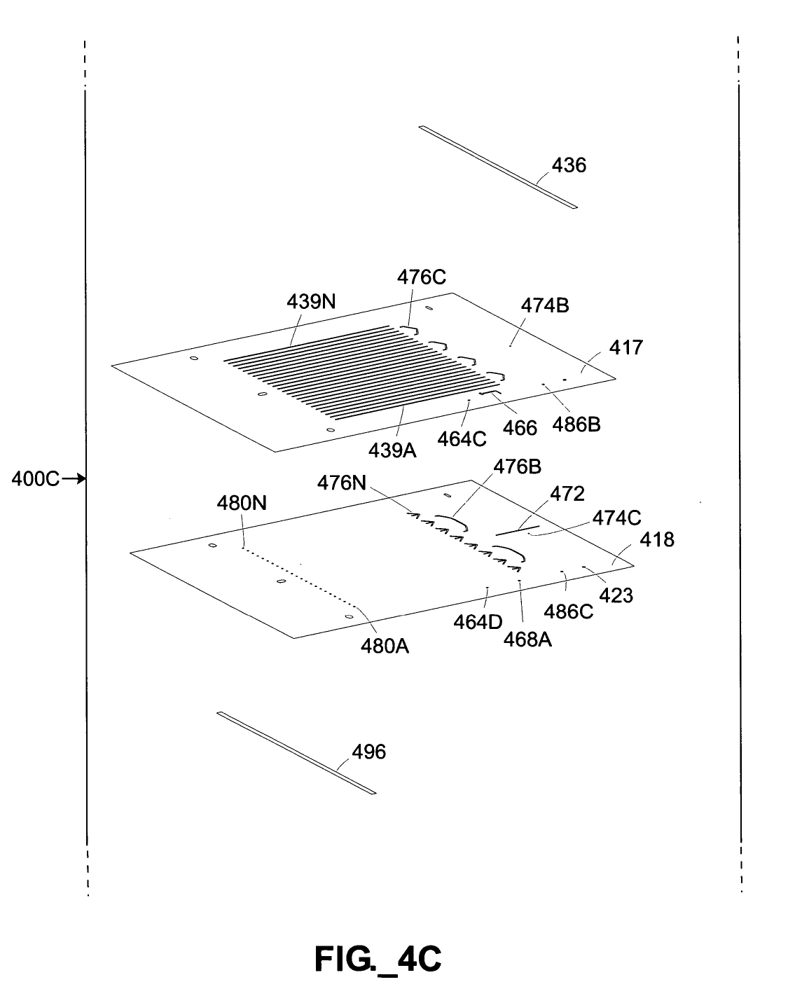

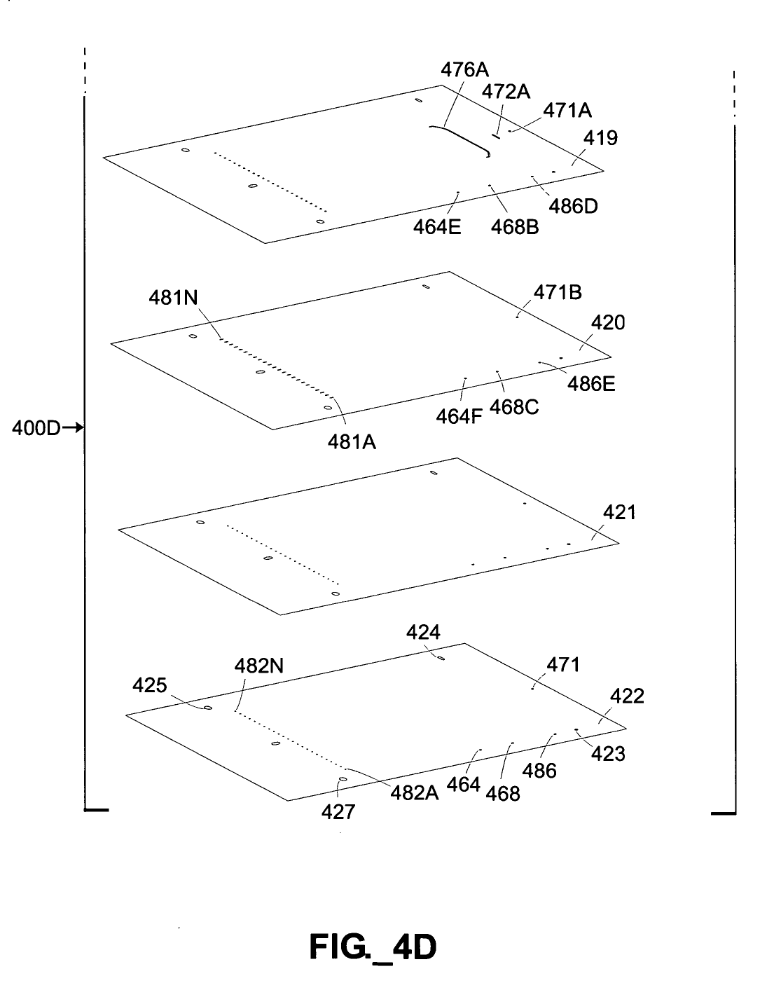

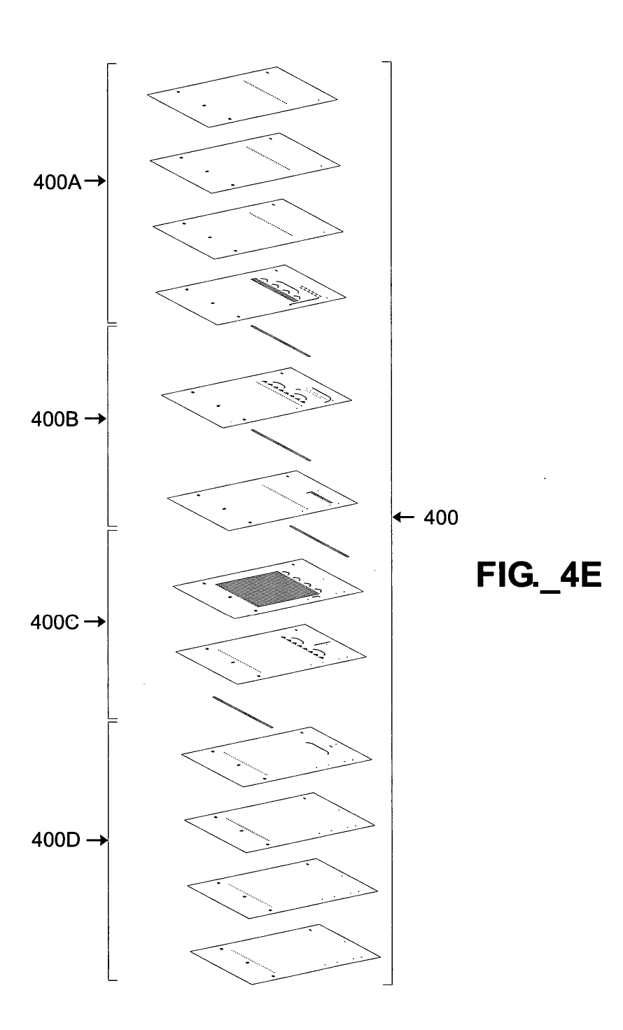

Another example of a multi-column microfluidic separation device suitable for performing pressure-driven liquid chromatography is provided in FIG. 3 and FIGS. 4A-4E. The device 400 includes twenty-four parallel separation channels 439A-439N containing stationary phase material. (Although FIG. 3 and FIGS. 4A-4E show the device 400 having eight separation columns 439A-439N, it will be readily apparent to one skilled in the art that any number of columns 439A-439N may be provided. For this reason, the designation “N” represents a variable and could represent any desired number of columns. This convention may be used elsewhere in this document.)

The device 400 may be constructed with twelve device layers 411-422, including multiple stencil layers 414-420 and two outer or cover layers 411, 422. Each of the twelve device layers 411-422 defines five alignment holes 423-427 (with hole 424 configured as a slot), which may be used in conjunction with external pins (not shown) to aid in aligning the layers during construction or in aligning the device 400 with an external interface (not shown) during a packing process or during operation of the device 400. Preferably, the device 400 is constructed with materials selected for their compatibility with chemicals typically utilized in performing high performance liquid chromatography, including, water, methanol, ethanol, isopropanol, acetonitrile, ethyl acetate, dimethyl sulfoxide, and mixtures thereof. Specifically, the device materials should be substantially non-absorptive of, and substantially non-degrading when placed into contact with, such chemicals. Suitable device materials include polyolefins such as polypropylene, polyethylene, and copolymers thereof, which have the further benefit of being substantially optically transmissive so as to aid in performing quality control routines (including checking for fabrication defects) and in ascertaining operational information about the device or its contents. For example, each device layer 411-422 may be fabricated from 7.5 mil (188 micron) thickness “Clear Tear Seal” polypropylene (American Profol, Cedar Rapids, Iowa).

Broadly, the device 400 includes various structures adapted to distribute particulate-based slurry material among multiple separation channels 439A-439N (to become separation columns upon addition of stationary phase material), to retain the stationary phase material within the device 400, to mix and distribute mobile phase solvents among the separation channels 439A-439N, to receive samples, to convey eluate streams from the device 400, and to convey a waste stream from the device 400.

The first through third layers 411-413 of the device 400 are identical and define multiple sample ports/vias 428A-428N that permit samples to be supplied to channels 454A-454N defined in the fourth layer 414. While three separate identical layers 411-413 are shown (to promote strength and increase the aggregate volume of the sample ports/vias 428A-428N to aid in sample loading), a single equivalent layer (not shown) having the same aggregate thickness could be substituted. The fourth through sixth layers 414-416 define a mobile phase distribution network 450 (including elements 450A-450N) adapted to split a supply of mobile phase solvent among twenty-four channel loading segments 454A-454N disposed just upstream of a like number of separation channels (columns) 439A-439N. Upstream of the mobile phase distribution network 450, the fourth through seventh layers 414-417 further define mobile phase channels 448-449 and structures for mixing mobile phase solvents, including a long mixing channel 442, wide slits 460A-460B, alternating channel segments 446A-446N (defined in the fourth and sixth layers 414-416) and vias 447A-447N (defined in the fifth layer 415).

Preferably, the separation channels 439A-439N are adapted to contain stationary phase material such as, for example, silica-based particulate material to which hydrophobic C-18 (or other carbon-based) functional groups have been added. One difficulty associated with prior microfluidic devices has been retaining small particulate matter within separation columns during operation. The present device 400 overcomes this difficulty by the inclusion of a downstream porous frit 496 and a sample loading porous frit 456. Each of the frits 456, 496 (and frits 436, 438) may be fabricated from strips of porous material, e.g., 1-mil thickness Celgard 2500 membrane (55% porosity, 0.209×0.054 micron pore size, Celgard Inc., Charlotte, N.C.) and inserted into the appropriate regions of the stacked device layers 411-422 before the layers 411-422 are laminated together. The average pore size of the frit material should be smaller than the average size of the stationary phase particles. Preferably, an adhesiveless bonding method such as one of the methods described previously herein is used to bond the device layers 411-422 (and frits 436, 438, 456, 496) together. Such methods are desirably used to promote high bond strength (e.g., to withstand operation at high internal pressures of preferably at least about 100 psi (690 kPa), more preferably at least about 500 psi (3450 kPa)) and to prevent undesirable interaction between any bonding agent and solvents and/or samples to be supplied to the device 400.

A convenient method for packing stationary phase material within the separation channels 439A-439N is to provide it to the device in the form of a slurry (i.e., particulate material mixed with a solvent such as acetonitrile). Slurry is supplied to the device 400 by way of a slurry inlet port 471 and channel structures defined in the seventh through ninth device layers 417-419. Specifically, the ninth layer 419 defines a slurry via 471A, a waste channel segment 472A, and a large forked channel 476A. The eighth device layer 418 defines two medium forked channels 476B and a slurry channel 472 in fluid communication with the large forked channel 476A defined in the ninth layer 419. The eighth layer 418 further defines eight smaller forked channels 476N each having three outlets, and twenty-four column outlet vias 480A-480N. The seventh layer 417 defines four small forked channels 476C in addition to the separation channels 439A-439N. In the aggregate, the large, medium, small, and smaller forked channels 476A-476N form a slurry distribution network that communicates slurry from a single inlet (e.g., slurry inlet port 471) to twenty-four separation channels 439A-439N (to become separation columns 439A-439N upon addition of stationary phase material). Upon addition of particulate-containing slurry to the separation channels 439A-439N, the particulate stationary phase material is retained within the separation channels by one downstream porous frit 496 and by one sample loading porous frit 456. After stationary phase material is packed into the columns 439A-439N, a sealant (preferably substantially inert such as UV-curable epoxy) is added to the slurry inlet port 471 to prevent the columns from unpacking during operation of the device 400. The addition of sealant should be controlled to prevent blockage of the waste channel segment 472A.

As an alternative to using particulate-based stationary phase material, microporous monoliths may be used in the columns 439A-439N. Generally, porous monoliths may be fabricated by flowing a monomer solution into a channel or conduit, and then activating the monomer solution to initiate polymerization. Various formulations and various activation means may be used. The ratio of monomer to solvent in each formulation may be altered to control the degree of porosity of the resulting monolith. A photoinitiator may be added to a monomer solution to permit activation by means of a lamp or other radiation source. If a lamp or other radiation source is used as the initiator, then photomasks may be employed to localize the formation of monoliths to specific areas within a fluidic separation device, particularly if one or more regions of the device body are substantially optically transmissive. Alternatively, chemical initiation or other initiation means may be used.

Numerous recipes for preparing monolithic columns suitable for performing chromatographic techniques are known in the art. In one embodiment a monolithic ion-exchange column may be fabricated with a monomer solution of about 2.5 ml of 50 millimolar neutral pH sodium phosphate, 0.18 grams of ammonium sulfate, 44 microliters of diallyl dimethlyammonium chloride, 0.26 grams of methacrylamide, and 0.35 grams of piperazine diacrylamide. Further specific recipes are provided, for example, in Ngola, S. M., et al., Conduct-as-cast polymer monoliths as separation media for capillary electrochromatography, Anal. Chem., 2001, vol. 73, pp. 849-856; in Shediac, R., et al., Reversed-phase Electrochromatography of amino acids and peptides using porous polymer monoliths, J. Chrom. A., 2001, vol. 925, pp. 251-263; and in Ericson, C., et al., Electroosmosis- and pressure-driven chromatography in chips using continuous beds, Anal. Chem., 2001, vol. 72, pp. 81-87, each of which are incorporated herein by reference.

To prepare the device 400 for operation, one or more mobile phase solvents may be supplied to the device 400 through mobile phase inlet ports 464, 468 defined in the twelfth layer 422. These solvents may be optionally pre-mixed upstream of the device 400 using a conventional micromixer (not shown). Alternatively, these solvents are conveyed through several vias (464A-464F, 468A-468C) before mixing. One solvent is provided to the end of the long mixing channel 442, while the other solvent is provided to a short mixing segment 466 that overlaps the mixing channel 442 through wide slits 460A-460B defined in the fifth and sixth layers 415, 416, respectively. One solvent is layered atop the other across the entire width of the long mixing channel 442 to promote diffusive mixing. To ensure that the solvent mixing is complete, however, the combined solvents also flow through an additional mixer composed of alternating channel segments 446A-446N and vias 447A-447N. The net effect of these alternating segments 446A-446N and vias 447A-447N is to cause the combined solvent stream to contract and expand repeatedly, augmenting mixing between the two solvents. The mixed solvents are supplied through channel segments 448, 449 to the distribution network 450 including one large forked channel 450A each having two outlets, two medium forked channels 450B each having two outlets, four small forked channels 450C each having two outlets, and eight smaller forked channels 450N each having three outlets.

Each of the eight smaller forked channels 450A-450N is in fluid communication with three of twenty-four sample loading channels 454A-454N. Additionally, each sample loading channel 454A-454N is in fluid communication with a different sample loading port 428A-428N. Two porous frits 438, 456 are disposed at either end of the sample loading channels 454A-454N. While the first frit 438 technically does not retain any packing material within the device, it may be fabricated from the same material as the second frit 456, which does retain packing material within the columns 439A-439N by way of several vias 457A-457N. To prepare the device 400 for sample loading, solvent flow is temporarily interrupted, an external interface (not shown) previously covering the sample loading ports 428A-428N is opened, and samples are supplied through the sample ports 428A-428N into the sample loading channels 454A-454N. The first and second frits 438, 456 provide a substantial fluidic impedance that prevents fluid flow through the frits 438, 456 at low pressures. This ensures that the samples remain isolated within the sample loading channels 454A-454N during the sample loading procedure. Following sample loading, the sample loading ports 428A-428N are again sealed (e.g., with an external interface) and solvent flow is re-initiated to carry the samples onto the separation columns 439A-439N defined in the seventh layer 417.

While the bulk of the sample and solvent that is supplied to each column 439A-439N travels downstream through the columns 439A-439N, a small split portion of each travels upstream through the columns in the direction of the waste port 485. The split portions of sample and solvent from each column that travel upstream are consolidated into a single waste stream that flows through the slurry distribution network 476, through a portion of the slurry channel 472, then through the short waste segment 472A, vias 474C, 474B, a frit 436, a via 484A, a waste channel 485, vias 486A-486E, and through the waste port 486 to exit the device 400. The purpose of providing both an upstream and downstream path for each sample is to prevent undesirable cross-contamination from one separation run to the next, since this arrangement prevents a portion of a sample from residing in the sample loading channel during a first run and then commingling with another sample during a subsequent run.

Either isocratic separation (in which the mobile phase composition remains constant) or, more preferably, gradient separation (in which the mobile phase composition changes with time) may be performed. Following separation, the eluate may be analyzed by flow-through detection techniques and/or collected for further analysis. Various types of detection may be used, such as, but not limited to, optical techniques including UV-Visible detection and spectrometric techniques including mass spectrometry. Off-board detectors such as flow cells may be used for flow-through detection techniques.

### Preferred Methods for Preparing Microfluidic Devices for Operation

In a preferred embodiment, gas (such as air) present within a microfluidic device is evacuated; thereafter or (less preferably) substantially simultaneously, liquid is introduced into the device using a positive pressure source such as a liquid pump. By removing gas from a microfluidic device prior to introducing liquid, the potential for detrimental bubble formation is greatly reduced, and a device may be placed into operation more quickly.

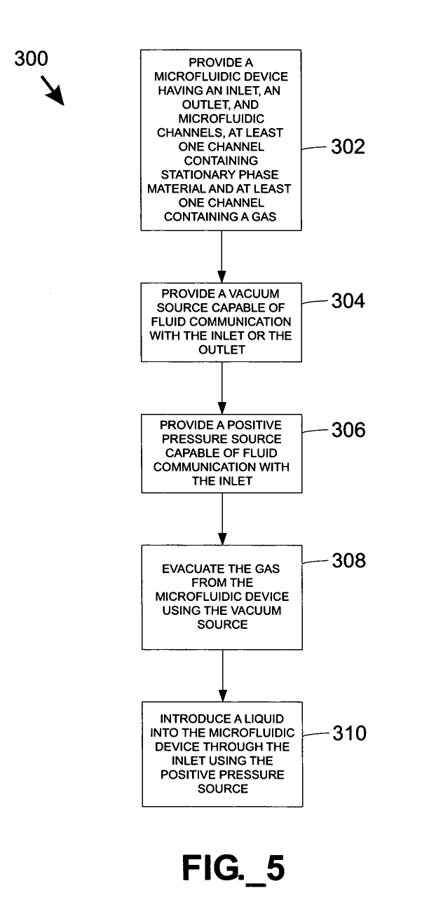

The steps of a method 300 for preparing a microfluidic device for initial operation are summarized in a flow chart in FIG. 5. A first step 302 includes providing a microfluidic device having an inlet, at least one outlet, at least one microfluidic channel containing stationary phase material, and at least one channel containing a gas. A second step 304 includes providing a vacuum source capable of (e.g., in periodic) fluid communication with either the inlet or outlet(s). A third step 306 includes providing a positive pressure source capable of (e.g., in periodic) fluid communication with the inlet. A fourth step 308 includes evacuating the gas from the microfluidic device using the vacuum source. A fifth step 310 includes introducing a liquid into the microfluidic device through the inlet using the positive pressure source. These method steps may be executed using components illustrated and described herein. Additional steps may be utilized. For example, the fluidic inlet may be temporarily sealed prior to (and during) the evacuation step. In another example, the vacuum source may be disconnected or otherwise isolated from the fluidic inlet or the fluidic outlet(s) prior to the liquid introduction step. Certain steps may include operating valves appropriately placed within a fluidic system. Preferably, liquid to be introduced to the microfluidic device is pressurized to at least about 100 psi to minimize bubble formation and facilitate high performance liquid chromatography. Particularly where hydrophobic materials are used within a microfluidic device, the liquid initially introduced to the device is an organic solvent such as, for example, acetonitrile, methanol, isopropyl alcohol, ethanol, ethyl acetate, or dimethyl sulfoxide.

Other similar methods may be used to evacuate gas from a microfluidic device to prepare it for operation. In one method, a first step includes providing a microfluidic device having an inlet and multiple microfluidic channels, at least one microfluidic channel containing a first gas. A second step includes temporarily sealing the device to prevent the admission of a second gas. A third step includes providing a fluidic connection between at least one microfluidic channel and a vacuum source. A fourth step includes evacuating the first gas from the microfluidic device using the vacuum source. Either or both of the first gas and the second gas may be air. Finally, a fifth step includes introducing a liquid into the microfluidic device through the inlet using a positive pressure source.

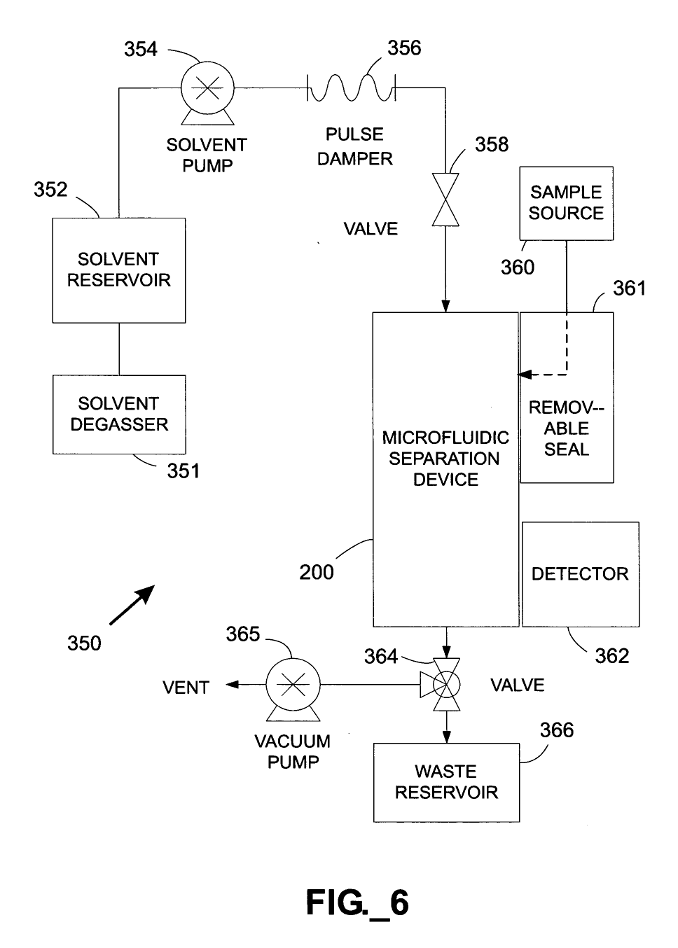

FIG. 6 is a schematic showing various components of a first separation system 350 adapted to quickly prepare a microfluidic separation device for operation. The system 350 includes various standard HPLC components, such as at least one solvent reservoir 352, at least one solvent degasser 351, at least one solvent pump 354, and a pulse damper 356. However, fluid connections to the microfluidic device 200 are preferably made with a removable seal 361, which may include one or more flat (e.g., gasketed or gasketless) surfaces sealed with compressive forces. One example of a preferred gasketless interface to a substantially planar microfluidic separation (HPLC) device is provided in commonly assigned U.S. patent application Ser. No. 10/649,073 (filed Aug. 26, 2003), which is hereby incorporated by reference as if set forth fully herein.

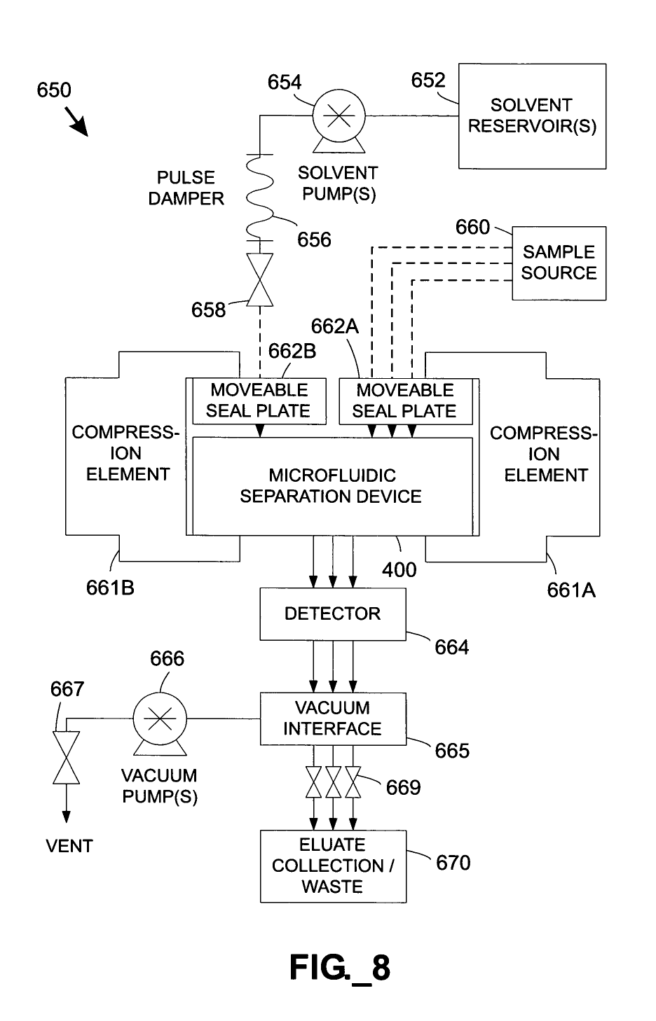

Samples from a sample source 360 are preferably injected directly onto separation columns (e.g., columns 245A-245H illustrated in FIGS. 2A-2B) rather than through a conventional upstream sample injection loop. Optical detection may be performed with an optical detector 362 through either on-device detection windows (e.g., windows 232 illustrated in FIGS. 2A-2B) or using off-device detection means (e.g., the detector 664 illustrated in FIG. 8). Components that may aid in preparing the device 200 for initial use (e.g., utilizing steps of the method 300 as described previously) include a first valve 358 disposed upstream of the device inlet, a second valve or diverter 364 disposed downstream of the device outlet(s), and a vacuum pump 365. The second diverter-type valve 364 is preferably a three-way valve capable of selectively establishing flow paths between the outlet(s) of the device 200 and a waste reservoir 366 or the vacuum pump 365. To execute the method 300, one or more fluidic inlets to the microfluidic device 200 may be sealed (i.e., to prevent fluid ingress) by closing the first valve 358. The first valve 358 may or may not be required, depending on the characteristics of the upstream components and fluid circuit. Connection between the vacuum source 365 and the device 200 may be established by operating the second valve 364. Gas such as air may then be evacuated from the device 200 by activating the vacuum pump 365. Ideally, the presence of gas should be eliminated not only from the device 200 but also from the upstream fluid circuit. One or more further connections (not shown) between the vacuum pump and fluid circuit upstream of the device 200 may be provided for this purpose. Upon evacuation of the device 200, the second valve 364 may be closed to maintain a sub-atmospheric condition within the device 200, and liquid may be introduced into the device 200 through the inlet using the solvent pump(s) 354. A suitable amount of solvent is supplied to the device 200 from the reservoir 352 by way of the pump(s) 354 to substantially fill the microfluidic channels disposed upstream of the detector 362. Introduction of liquid into a substantially gas-free device 200 helps to eliminate or at least reduce bubble formation, thus reducing the time required to flush bubbles from the system 350 and permitting the device 200 to be operated (e.g., start separating samples) more quickly. The operating pressure is preferably at least about 100 psi, more preferably at least about 200 psi, and more preferably still at least about 400 psi.

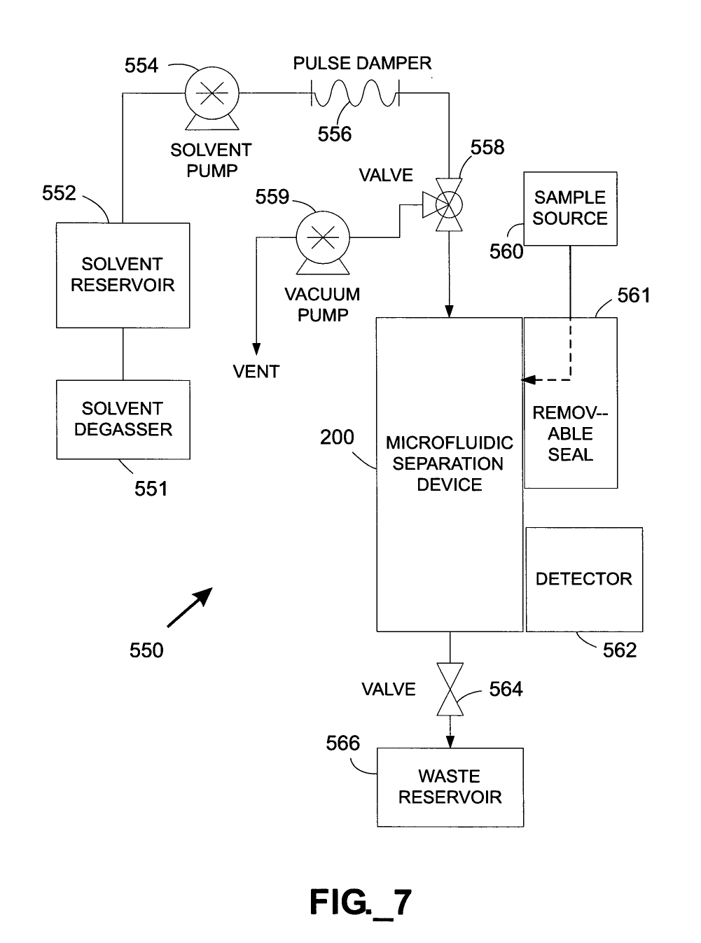

FIG. 7 is a schematic showing various components of a separation system 550 adapted to utilize a second chip preparation method according to the present invention. Like in the previous system 350, various standard HPLC components, such as at least one solvent reservoir 552, at least one solvent degasser 551, at least one solvent pump 554, and a pulse damper 556 may be used. Likewise, fluid connections to the microfluidic device 200 are preferably made with a removable seal 561, and samples from a sample source 560 are preferably injected directly onto separation columns (such as columns 245A-245H illustrated in FIGS. 2A-2B) rather than through a conventional upstream sample injection loop. An optical detector 562 may be disposed proximate one or more detection region that are preferably integral to the device 200. To aid in preparing the microfluidic separation device 200 for initial use, the following components may be provided: a first valve or diverter 558 disposed upstream of the device inlet, a second valve 564 disposed downstream of the device outlet(s), and a vacuum pump 559. The first valve 564 is preferably capable of selectively establishing flow paths between the inlet of the device 200 and the vacuum pump 559.

To execute the above-described device preparation method 300, the outlet(s) of the microfluidic device 200 may be sealed (i.e., to prevent fluid, such as air, ingress) by closing the second valve 564. The first valve 558 is then opened to evacuate any gas from the device 200 (and, if desired, from the upstream components). Upon evacuation of the device 200, the second valve 564 should remain closed to maintain a sub-atmospheric condition within the device 200, and the first valve 558 is then closed to prevent fluid communication with the vacuum pump 559. Thereafter, liquid may be introduced into the device 200 through the inlet using the pump(s) 554 or other equivalent positive pressure source. A suitable amount of solvent is supplied to the device 200 from the reservoir 552 by way of the pump(s) 554 to substantially fill the microfluidic channels disposed upstream of the detector 562. As before, Introduction of liquid into a substantially gas-free device 200 reduces or eliminates the presence of bubbles within the system 550, thus permitting the device 200 to be operated (e.g., start separating samples using pressure-driven liquid chromatography) more quickly.

Another system adapted to quickly prepare a microfluidic separation device for operation is illustrated in FIG. 8. Again, the system 650 utilizes many conventional HPLC system components including at least one solvent reservoir 652, at least one solvent degasser (not shown), at least one solvent pump 654, a pulse damper 656, and an off-board detector 664 such as may include multiple low volume flow cells to provide flow-through detection capability using any of various detection technologies such as UV-Visible or fluorescence detection. One or more valves 658 may be disposed between the solvent pump(s) 654 and the microfluidic device 400. The system 650 includes a sample source 660 for supplying multiple samples to a multi-column microfluidic separation device 400. The device 400 is in fluid communication with the sample source 660 by way of a first moveable seal plate 662A that is actuated with a first compression element 661A. Further, the device 400 is in fluid communication with the solvent supply components (e.g., solvent reservoir(s) 652, solvent pump(s) 654, and pulse damper 656) by way of a second moveable seal plate 662B that is actuated with a second compression element 661B. Preferably, the each compression element 661 A, 661 B may be actuated independently. A vacuum interface 665 is preferably disposed downstream of the detector 664 to eliminate undesirable gas from both the separation device 400 and the detector 664. The vacuum interface 665 may include multiple diverter valves (e.g., such as the valves 364 described previously in connection with FIG. 6). Alternatively, the vacuum interface 665 may include one or more gas-permeable materials that disallow the passage of liquid, with the gas-permeable materials in fluid communication with one or more vacuum pumps 666. The vacuum interface 665 may further include an internal manifold may be provided to permit a single vacuum pump 666 to evacuate multiple fluid channels from the detector 664. Eluate collection and/or waste components 670 may be provided downstream of the vacuum interface 665. Additional valves 669 may be provided between the vacuum interface 665 and the eluate collection/waste component(s) 670, with a valve 667 downstream of the vacuum pump(s) 666.

To prepare the device 400 for operation, the seal plates 662A-662B are pressed against the device 400 using the compression elements 661A-661B. The upstream valve(s) 658 and any downstream valves 669 are preferably closed. The vacuum pump(s) 666 are actuated to evacuate any gaseous contents of the microfluidic device 400 and the detector 664. With gas (e.g., air) evacuated from the microfluidic device 400, the solvent supply valve 658 may be opened and the solvent pump(s) 654 activated to supply pressurized solvent to the device 400 while minimizing the presence of bubbles within the device 400 and detector 664. Preferably, the vacuum pump(s) 666 are deactivated before or as the positive pressure solvent pump(s) 654 are activated. After the device 400 is filled with pressurized solvent, samples may be added to the device 400 from the sample source 660 and chromatographically separated with the downstream valves 669 open. Following detection in the detector 664, liquid eluate flows through the vacuum interface 665 to eluate collection/waste 670.

It is to be understood that the illustrations and descriptions of views of individual microfluidic devices, components, and method steps provided herein are intended to disclose specific examples to assist a skilled artisan in practicing the invention, and not intended to limit the scope of the invention. Various arrangements, combinations, and/or further additions of individual devices, components, and method steps provided herein are contemplated, depending on the requirements of the particular application.

What is claimed is:

1. A method for preparing a microfluidic device for operation, the method comprising the steps of:
providing a microfluidic device having a fluidic inlet, at least one fluidic outlet, a plurality of microfluidic channels disposed between the fluidic inlet and the fluidic outlet, and separation media disposed within at least one microfluidic channel of the plurality of microfluidic channels, between the fluidic inlet and the fluidic outlet, with at least one microfluidic channel of the plurality of microfluidic channels containing a gas;
providing a vacuum source in at least periodic fluid communication with at least one of the fluidic inlet and the at least one fluidic outlet;
providing a positive pressure source in at least periodic fluid communication with the fluidic inlet;
evacuating the gas from the microfluidic device using the vacuum source; and
introducing a liquid into the microfluidic device through the inlet using the positive pressure source.

2. The method of claim 1, further comprising the step of temporarily sealing the fluidic inlet prior to the evacuation step.

3. The method of claim 1 wherein the gas comprises air.

4. The method of claim 1 wherein the separation media comprises packed or microporous stationary phase material.

5. The method of claim 1 wherein the device further comprises a hydrophobic frit material.

6. The method of claim 1 wherein the liquid is an organic solvent selected from the group consisting of acetonitrile, methanol, isopropyl alcohol, ethanol, ethyl acetate, and dimethyl sulfoxide.

7. The method of claim 1, further comprising the step of disallowing fluid communication between the vacuum source and at least one of the fluidic inlet and the at least one fluidic outlet prior to the liquid introduction step.

8. The method of claim 1 wherein the temporarily sealing step includes operating a valve.

9. The method of claim 1 wherein the vacuum source comprises a vacuum pump.

10. The method of claim 1 wherein the positive pressure source comprises a liquid pump.

11. The method of claim 1 wherein the liquid introduction step includes supplying liquid pressurized to at least about 100 psi to the microfluidic device.

12. The method of claim 1 wherein:
the microfluidic device has a plurality of fluidic outlets;
the vacuum source is in fluid communication with at least two fluidic outlets of the plurality of fluidic outlets; and
the gas is evacuated from the microfluidic device through the at least two fluidic outlets.

13. A microfluidic system comprising:
a microfluidic device having a fluidic inlet, a plurality of fluidic outlets, a microfluidic distribution network, a plurality of microfluidic separation columns containing stationary phase material and in fluidic communication with the plurality of fluidic outlets and in fluid communication with fluidic inlet through the distribution network;
a vacuum source in at least periodic fluid communication with the plurality of separation columns; and
a positive pressure source in at least periodic fluid communication with the fluidic inlet;
wherein the vacuum source is adapted to evacuate a gas from the plurality of separation columns.

14. The system of claim 13 wherein the gas comprises air.

15. The system of claim 13 wherein the separation media comprises packed or microporous stationary phase material.

16. The system of claim 13 wherein the device further comprises a hydrophobic frit material.

17. The system of claim 13 wherein the liquid is an organic solvent selected from the group consisting of acetonitrile, methanol, isopropyl alcohol, ethanol, ethyl acetate, and dimethyl sulfoxide.

18. The system of claim 13, further comprising an inlet valve disposed between the positive pressure source and the fluidic inlet.

19. The system of claim 13, further comprising at least one outlet valve disposed between the vacuum source and the plurality of fluidic outlets.

20. The system of claim 13 wherein the vacuum source comprises a vacuum pump.

21. The system of claim 13 wherein the positive pressure source comprises a liquid pump.

22. The system of claim 13 wherein the positive pressure source is adapted to supply liquid pressurized to at least about 100 psi.
